(19) United States
(12) Patent Application Publication
(10) Pub. No.: US 2007/0119830 A1
(43) Pub. Date: May 31, 2007

(54) Method for connecting components

(75) Inventor: Reinhold Meier, Dorfen (DE)

Correspondence Address: DAVIDSON, DAVIDSON & KAPPEL, LLC, 485 SEVENTH AVENUE, 14TH FLOOR, NEW YORK, NY, 10018, US

(73) Assignee: MTU Aero Engines GmbH, Muenchen (DE)

(21) Appl. No.: 10/588,538

(22) PCT Filed: Jan. 28, 2005
(86) PCT No.: PCT/DE05/00132

§ 371 Date: Aug. 7, 2006

(30) Foreign Application Priority Data
Feb. 7, 2004 (DE) 10 2004 006 154.8

(51) Int. Cl. B23K 26/34; B23K 15/00

(52) U.S. Cl. 219/121.64; 219/121.14

(57) ABSTRACT

A method for connecting dynamically loaded components, especially gas turbine components is provided. At least two components (10, 11; 14, 15) to be interconnected are connected by means of laser powder build-up welding.

The present invention relates to a method for joining components under dynamic load, in particular gas turbine components, according to the definition of the species in patent claim 1.

Components of gas turbines under high dynamic loads in particular are as a rule manufactured as forgings since forgings have greater strength compared to castings. According to the related art, friction welding, in particular rotational friction welding or linear friction welding, is used for joining such components under dynamic load. Strength values, which correspond to the strength values of the forged material, may be achieved for the joint area between two components by using friction welding. Rotational friction welding is among the group of what is known as pressure welding techniques which all have the disadvantage that they must be carried out on complex machines and involve expensive manufacturing resources. Joining components under dynamic load via friction welding or pressure welding is thus complex and expensive. Moreover, a welding bulge (known as flash) forms during friction welding or pressure welding which requires complex further machining. Fusion welding techniques known from the related art, however, cannot be used for joining components under dynamic load since the strength of fusion welded joints is not adequate for components under high dynamic loads.

Therefore, the object of the present invention is based on providing a novel method for joining components under dynamic load, in particular gas turbine components.

This object is achieved by a method for joining components under dynamic load, in particular gas turbine components, according to patent claim 1. According to the present invention, at least two components to be joined are joined together using laser build-up welding.

Within the scope of the present invention it is proposed that components under dynamic load be joined using laser powder build-up welding. According to the related art, laser powder build-up welding is merely used for manufacturing components or new parts by way of what is known as rapid manufacturing processes. The present invention proposes for the first time the use of laser powder build-up welding for joining components under dynamic load. The present invention is based on the recognition that, using laser powder build-up welding, joints may be achieved whose strength values are higher than the strength values of forged components. This is due to the fact that in laser powder build-up welding the welded material cools down rapidly and freezes in position. The structure of the weld being formed in the process is fine-grained. The joint produced in this way thus has outstanding strength characteristics and is particularly well suited for joining components under dynamic load. Additional advantages of the present invention are the high flexibility of laser powder build-up welding as well as little pretreatment and after-treatment complexity of the weld.

According to an advantageous refinement of the present invention, the components to be joined are aligned relative to one another and are joined together in this aligned position by an auxiliary weld. Subsequently to producing the auxiliary weld, the actual joint of the components is established via laser powder build-up welding.

Preferred refinements of the present invention arise from the subclaims and the following description. Without being restricted thereto, an exemplary embodiment of the present invention is explained in greater detail based on the drawing.

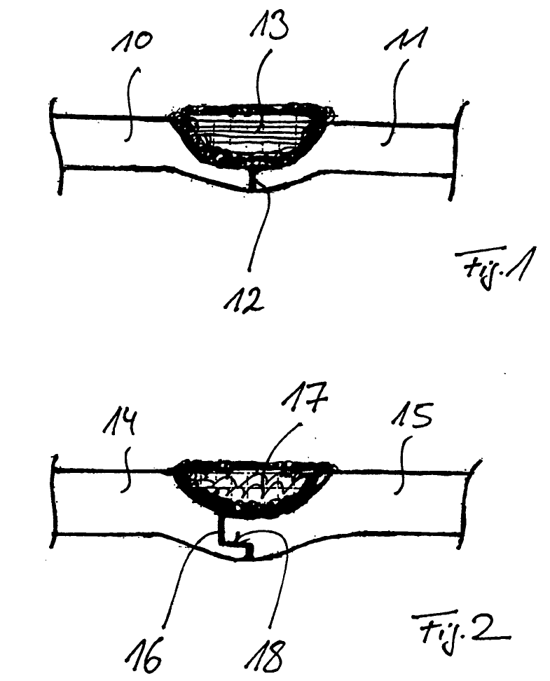

FIG. 1 shows a highly schematized view of two components under dynamic load joined by the method according to the present invention, and

FIG. 2 shows a highly schematized view of two additional components under dynamic load joined by the method according to the present invention.

The present invention is described in greater detail in the following with reference to FIGS. 1 and 2.

FIG. 1 shows sections of two components to be joined, both components being designed as rotor discs of a gas turbine rotor which are to be joined together on axially extending flanges 10, 11.

Within the scope of the method according to the present invention, the two components are joined together at flanges 10, 11 by initially aligning components 10, 11 relative to one another and temporarily joining them in this aligned position by an auxiliary weld 12. Subsequently to producing auxiliary weld 12, both components are joined together permanently by laser powder build-up welding, a weld produced by laser powder build-up welding being identified by reference numeral 13 in FIG. 1.

As is apparent in FIG. 1, flanges 10, 11 form a pool crater in the area of the flange ends to be joined together into which, for establishing weld 13, material for weld 13 may be introduced by laser powder build-up welding. The powder used in laser powder build-up welding is adapted to the material composition of the components to be joined together.

During laser powder build-up welding, the powder is melted and is subject to a rapid cool-down so that the melted material freezes in position during cool-down. A fine-grained structure forms in the area of weld 13. Weld 13 thus has strength values which are higher than the strength values of the base material of the components to be joined together. Cooling-down of the material during laser powder build-up welding and thus the strength value of the resulting weld 13 may be influenced by appropriate cooling.

As is apparent in FIG. 1, weld 13 produced by laser powder build-up welding protrudes slightly over the dimensions of flange 10. This section of weld 13 protruding over flange 10 may be removed during an after-treatment of weld 13. However, the after-treatment effort is little since it is possible to apply material for forming weld 13 in a targeted and highly accurate manner by laser powder build-up welding.

FIG. 2 shows two additional components to be joined together, namely two rotor discs which are to be joined together in the area of axially extending flanges 14 and 15. For producing the joint of the components at flanges 14, 15 according to FIG. 2, one proceeds in a way similar to the exemplary embodiment of FIG. 1 in such a way that both components are initially aligned relative to one another and joined in this aligned position with the aid of an auxiliary weld 16. Subsequently to producing auxiliary weld 16, the actual joint of the components is established via a weld 17 which is produced by laser powder build-up welding.

The exemplary embodiment of FIG. 2 differs from the exemplary embodiment of FIG. 1 merely by the fact that alignment of the components is facilitated in that a shoulder-shaped or step-shaped centering lip 18 exists in the area of the ends of flanges 14 and 15 to be joined together. Centering lip 18 is used for easier alignment of the components relative to one another.

It should be pointed out that a weld 13 having a gradient may also be produced in that the material used for laser powder build-up welding is adapted, for example, or that the welding conditions, such as the temperature, are modified.

Using the present invention, joints on components under high dynamic loads may be produced cost-effectively without applying the great force required in friction welding. This makes it possible to dispense with complex equipment, machines, and special manufacturing resources. Laser powder build-up welding is very flexible and requires only little after-treatment of the weld. Strength values of the weld may be achieved which are higher than the strength values of the base material of the components to be joined together.

1-5. (canceled)

6. A method for joining components under dynamic load comprises welding at least two gas turbine components laser powder build-up welding to join said at least two gas turbine components together.

7. The method of claim 1, further comprising, prior to said step of welding:
aligning the at least two components relative to one another in an aligned position; and
joining the at least two components together in the aligned position by an auxiliary weld.

8. The method as recited in claim 6, wherein the auxiliary weld is produced by laser welding or electron-beam welding.

9. The method as recited in claim 6, wherein the at least two gas turbine components comprise at least two rotor discs of a compressor rotor or a turbine rotor, each of the at least two rotor discs including an axially extending flange; and wherein the step of welding joins together the at least two rotor discs at said axially extending flanges of said at least two rotor discs.

10. The method as recited in claim 7, wherein the at least two gas turbine components comprise at least two rotor discs of a compressor rotor or a turbine rotor, each of the at least two rotor discs including an axially extending flange;
wherein the step of aligning includes axially aligning the axially extending flanges;
wherein the step of joining comprises forming an auxiliary weld at an intersection of the axially extending flanges;
and wherein the step of welding joins together the at least two rotor discs at said axially extending flanges of said at least two rotor discs.

11. The method of claim 10, wherein the axially extending flanges of said at least two rotor discs, when aligned, form a pool crater for the laser powder build up welding.
